(19) United States
(12) Patent Application Publication
(10) Pub. No.: US 2004/0088063 A1
(43) Pub. Date: May 6, 2004

(54) Audio delivery system

(75) Inventors: Tetsuo Hoshi, Tokyo (JP); Shusaku Aizawa, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: YOKOGAWA ELECTRIC CORPORATION, Tokyo (JP)

(21) Appl. No.: 10/688,945

(22) Filed: Oct. 21, 2003

(30) Foreign Application Priority Data
Oct. 25, 2002 (JP) 2002-310710

(51) Int. Cl. G06F 17/00

(52) U.S. Cl. 700/94

(57) ABSTRACT

The present invention is characterized by the following points:

An audio delivery system can be achieved, in which a terminal can directly receive audio data related to products, catalogs, etc. via the Internet and a user can, using the terminal and a server listen to the data before purchasing; the terminal comprises a network address which is uniquely determined according to Internet Protocol Version 6 (IPv6), reading the identifying information from the identifying information recording part attached to a prescribed article, sending this identifying information to a preset server via a network as well as converting the received audio data to audible sounds or voices; the server sends the audio data related to the article to the terminal based on the received identifying information via the network.

### BACKGROUND OF THE INVENTION

1. Field of the Invention

The present invention relates to an audio delivery system which delivers audio information, related to identifying information sent from a terminal to a server, to the terminal from the server.

2. Description of the Prior Art

Conventional audio delivery systems include, for example, a compact disc (hereafter abbreviated as CD) listening system. This is a system which facilitates a bar code reader incorporated in a terminal anchored in position in a store to read the bar code on a CD package thereby acquiring music data corresponding to the bar code from a server via a wired network.

This will be described using a drawing.

FIG. 1 is a configuration drawing indicating an example of a conventional audio delivery system in which the system is applied to a CD listening system.

In FIG. 1, in store 1, multiple units of listening terminal 11, local server 12 and router 13 are connected through Local Area Network (hereafter called LAN) 14.

Listening terminal 11 reads bar code 16 attached to the package of desired to listen to CD 15 and sends the identifying information of CD 15 to local server 12 via LAN 14. Since listening terminal 11 is anchored in position, CD 15 is held up to listening terminal 11 for the reading of bar code 16.

Local server 12 receives the identifying information, searches for listening data corresponding to the identifying information and delivers the data to listening terminal 11. Local server 12 also acquires and controls information of utilization such as what was delivered to each listening terminal 11.

Global server 18 is connected to Internet 17 in a location remote from store 1. Data such as new tunes are downloaded from global server 18 to local server 12 in advance. Delivery data are downloaded via Internet 17.

In some cases, data are directly delivered from listening terminal 11 to global server 18 which is connected to Internet 17 without installing local server 12 in store 1.

In the case where more than one terminal and the like is connected to LAN 14 and then connected to the Internet, it is currently necessary to use the Network Address Translation (hereafter called NAT) function which allocates private IP addresses to each terminal and the like and enables them to access the Internet by allocating intrinsic IP addresses only when accessing Internet 17 from store 1, due to restrictions to the communication protocol.

Router 13 has the NAT function and serves as a repeater in LAN 14 if connecting to Internet 17 from LAN 14.

In addition, explanation systems for exhibitions are used in modern museums and art museums and among these there are some systems using wireless terminals which are receivers using weak FM radio waves or the like.

Further, there is such a system having a configuration in which a bar code reader, a wireless transceiver, an earphone jack and a battery are provided in a pen-shaped unit. The bar code reader sends product identifying codes attached to packages of music products to the central computer of the record shop, and the central computer, which stores a plurality of music samples, then sends the relevant music sample to the pen-shaped unit (for example, refer to patent document 1).

### Patent Document 1

Gazette of Japanese Laid-open Patent Application No. 10-0232690

In the above described conventional audio delivery system, since delivery source servers such as local server 12 and global server 18 are fixed to listening terminal 11, only stereotyped information data are delivered and a plurality of other related information data cannot be delivered.

Also, as delivery source servers are anchored in position, one server must hold all the delivery data. Accordingly, if it is assumed that all of the audio data the volume of which may be vast are administrated, a very large memory capacity would be required.

Further, in the case of delivering speech-based information such as explanations, advertising or promotional materials, etc. relative to exhibitions, products, or the like, a very large memory capacity becomes necessary if it is assumed that such information data are stored in a server in the form of speech data.

In addition, if there are many listening terminals, it is difficult with the present communication protocol to set network addresses determined uniquely even outside LAN 14 to all of listening terminals 11. Accordingly, if access to a server outside LAN 14 is to be attempted, the NAT function is unavoidably required and thus access cannot be utilized only with listening terminals. Similarly, each terminal cannot be directly accessed from a global server located outside LAN.

Furthermore, in conventional audio delivery systems, although information of utilization can be acquired and controlled at every terminal, customer information cannot be collected and stored due to lack of functions to administrate information for every user.

The problems described above are inherent in conventional audio delivery systems.

### SUMMARY OF THE INVENTION

The present invention is intended to solve the above described problems, therefore its object is to offer an audio delivery system in which more than one terminal can directly access more than one server via the Internet, the amount of data to be delivered that are stored in servers is reduced, and in addition, customer information can also be acquired.

### BRIEF DESCRIPTION OF DRAWINGS

[FIG. 1]

FIG. 1 is a configuration drawing indicating an example of conventional audio delivery systems.

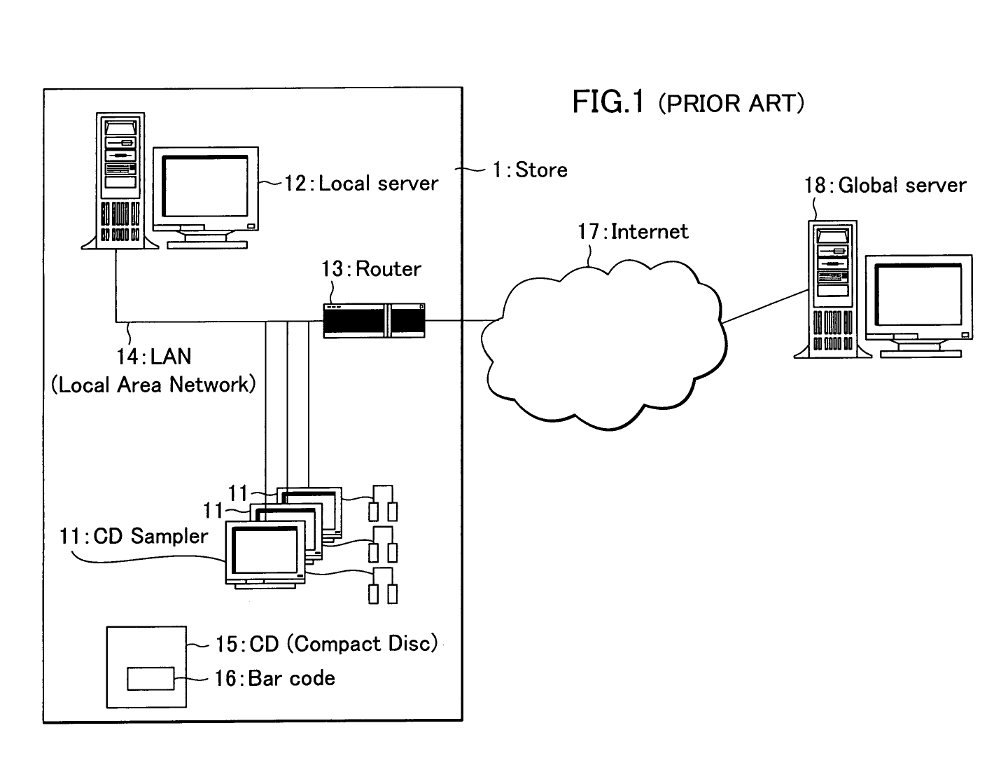

[FIG. 2]

FIG. 2 is a configuration drawing indicating embodiment 1 of the present invention.

[FIG. 3]

FIG. 3 is a flow chart showing an example of the operating procedure for a terminal of the present invention.

[FIG. 4]

FIG. 4 is a configuration drawing indicating an example of a terminal of the present invention.

[FIG. 5]

FIG. 5 is a configuration drawing indicating an example of a server of the present invention.

[FIG. 6]

FIG. 6 is a configuration drawing indicating embodiment 2 of the present invention.

### DESCRIPTION OF THE PREFERRED EMBODIMENTS

The present invention will be described below in detail using drawings.

### Embodiment 1

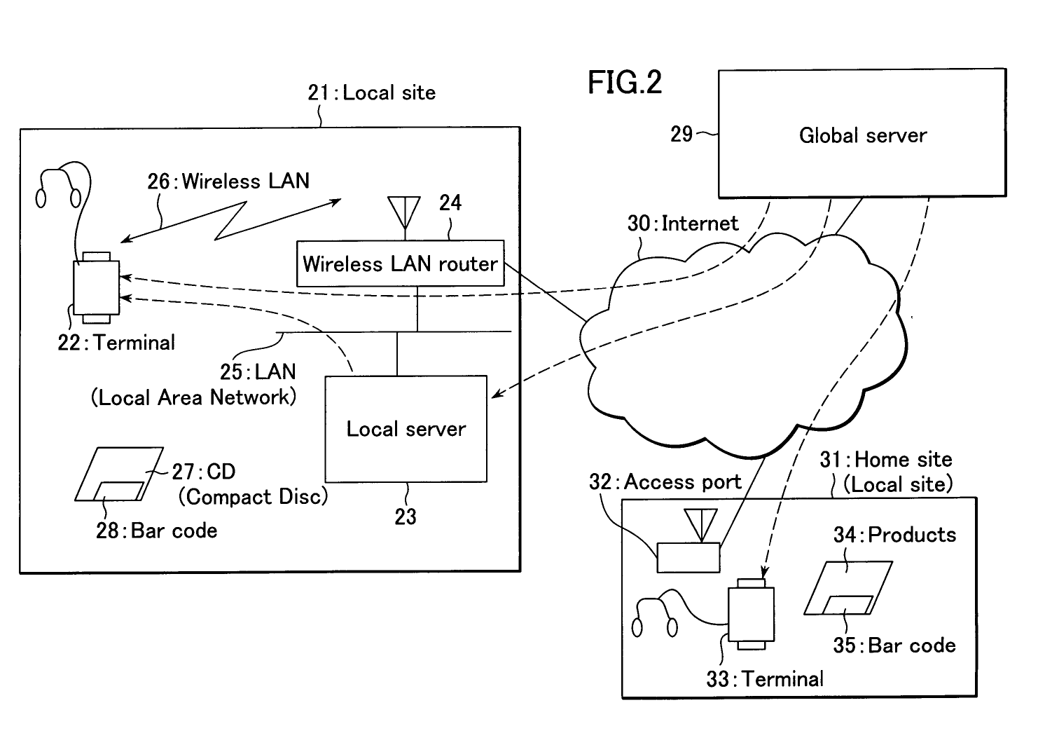

FIG. 2 is a configuration drawing indicating embodiment 1 of the present invention.

FIG. 2 shows an embodiment of an audio delivery system in the case where the audio delivery system is applied to a music delivery system. Dashed lines with arrows show the flows of audio data.

In FIG. 2, at local site 21 such as a store, LAN 25 is comprised of terminal 22, local server 23 and wireless LAN router 24. In this case, more than one terminal 22 (not shown in the drawing) at local site 21 can be connected to LAN 25.

In this embodiment, terminal 22 implements communication using wireless LAN 26. Even if more than one terminal exists, terminal 22 is easily enabled to have a uniquely determined network address (global address) by applying Internet Protocol Version 6 (IPv6) to terminal 22. Terminal 22 reads and sends the identifying information attached to CD 27 using bar code 28 and receives the corresponding delivered audio data to play back.

Local server 23 stores multiple audio data groups to be delivered and delivers the corresponding audio data to terminal 22 depending on the identifying information and the delivery request sent from terminal 22. Global server 29 is connected to Internet 30 and delivers audio data contained in global server 29 to the terminal, by receiving transfer of a delivery request, if the audio data requested from the terminal do not exist in local server 23.

In this case, global addresses are also set to local server 23 and global server 29 according to IPv6.

Wireless LAN router 24 connects terminal 22 and server 23 which are connected to LAN 25 at local site 21 and to Internet 30, and also serves as a repeater in LAN 25. In this embodiment, wireless LAN router 24 also serves as a repeater (base station) for wireless LAN 26. Possession of a global address by terminal 22 enables terminal 22 to be connected to Internet 30 without requiring the NAT function and to access global server 29 without address conversion.

The inside of home site 31 is an area outside local site 21, provided with access port (base station) 32 for making LAN wireless, and includes, for example, “hot spots” (registered trademark) (locations where connection to the Internet can be made using wireless LAN in stores, hotels or railway stations) and the like. As previously described, more than one terminal 33 to be connected to LAN (not shown in the drawing) in home site 31 may exist.

Terminal 33 in home site 31 also has the same configuration as terminal 22 in local site 21 and can request delivery by reading bar code 35 attached to product 34 and directly accessing global server 29.

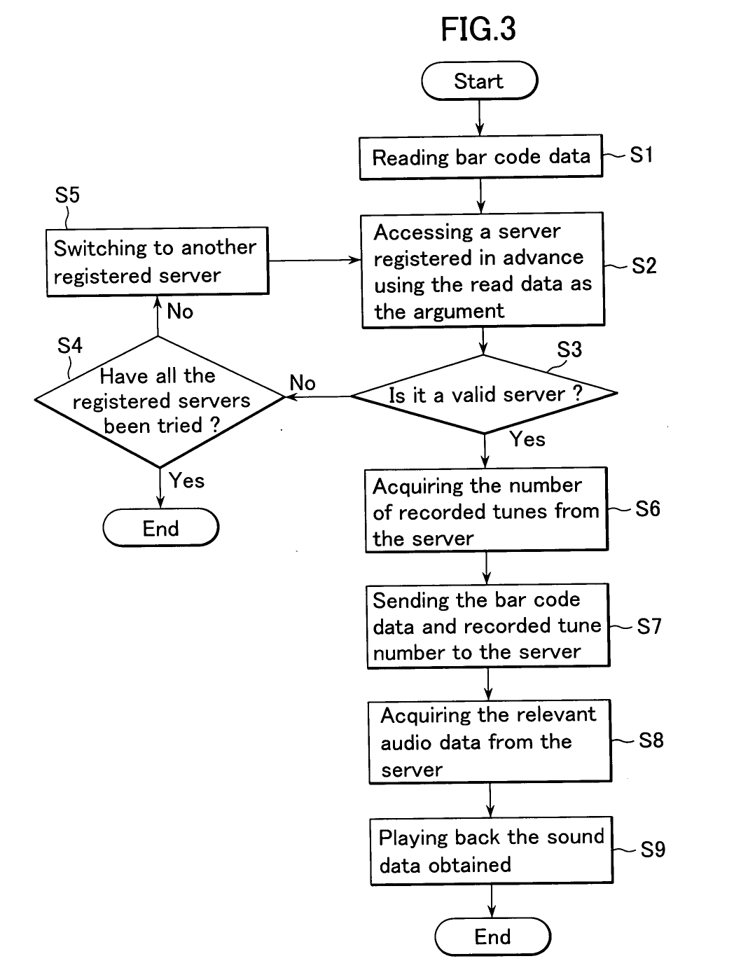

FIG. 3 is a flow chart showing an example of the operating procedure for a terminal of the present invention.

Now, an explanation according to the procedures in this flow chart will be made.

(S1) Bar code data are read.

(S2) A server registered in advance is accessed using the read data as the argument.

(S3) The accessed server is judged as to whether it is valid or not. If it is not valid, processing shown in step S4 is carried out, while if it is valid, processing shown in step S6 is carried out.

(S4) Whether an attempt to access all the registered servers has been made is judged. If all the servers have not been tried, processing shown in step S5 is carried out, while if all the servers have been tried, processing should be terminated.

(S5) After switching to another registered server, the processing shown in step S2 is carried out.

(S6) After a server is judged to be valid in step S3, how many recorded tunes are there on a CD is acquired from the server.

(S7) The bar code data and the recorded tune number specified by a user are sent to the server.

(S8) Relevant audio data are acquired from the server.

(S9) The processing is completed by playing back the sound data obtained.

Although it is configured in the flow chart in FIG. 3 that the delivery data are identified from the number of recorded tunes in the CD and the recorded tune number, a process identifying the delivery data and an address for the data and the like from the data read from the bar code may be provided in lieu of the above process.

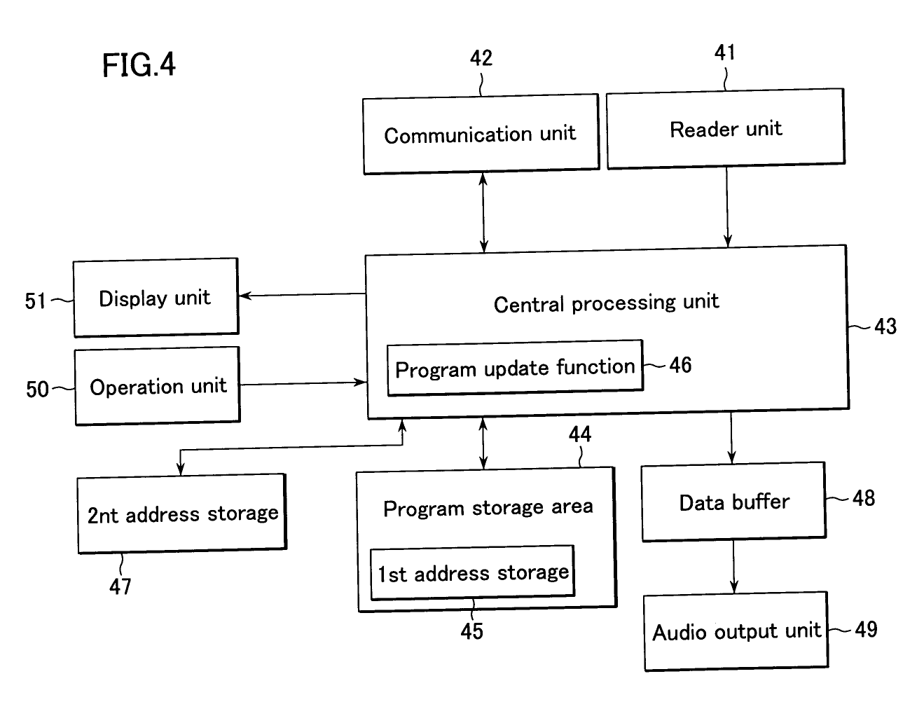

FIG. 4 is a configuration drawing indicating an embodiment of a terminal of the present invention.

In FIG. 4, reader unit 41 reads identifying information from a bar code attached to articles such as CDs, catalogs, etc., or it reads identifying information by receiving that information which has been transmitted by means of radio waves or infrared rays. This reading causes the above identifying information to be input to a terminal as a numeric value code.

Communication unit 42 sends requests for delivery of the identifying information and audio data or receives audio data sent from a server.

Central processing unit 43 consists of processors and others and executes programs read from the program storage area to control the whole terminal.

Program storage area 44 stores programs for the control of terminals. This area includes 1st address storage 45 in which data for network addresses are stored.

These network addresses are those uniquely determined according to IPv6, and individual terminals can access an outside server independently via the Internet through control by central processing unit 43 using these addresses as well as being accessible from an outside server. In other words, communication between a server and a terminal can be implemented end-to-end without the intervention of NAT.

Further, a program in program storage area 44 is updated to another program acquired from outside via communication unit 42 by program update function 46 included in central processing unit 43. This facilitates the addition of new functions and the release of an upgraded version or the like.

In 2nd address storage 47, the network address data for specifying servers to be accessed are stored. Central processing unit 43 acquires these network address data and controls the terminals to access the corresponding server. Network address data are also added or updated by program update function 46.

In addition, the network address includes the concept of Uniform Resource Locators (URLs) and others, and it suffices to identify the server to be accessed.

Data buffer 48 is a buffer memory for playing back uninterrupted audio data to be delivered from a server.

Delivered audio data can also be fetched from a terminal by providing storage media or interfaces (not shown in the drawing).

Audio output unit 49 decodes encoded data by extracting compressed audio data, and then converts them to audible sounds or voices through speakers or earphones.

Operation unit 50 is provided with keys for turning the power on and off, for controlling sound volume, for forwarding or reversing a track for tunes, and for other functions, and the user operates terminals via the operation unit.

Display unit 51 displays the track number indicating a sequence of tunes or the like and any error messages or error codes.

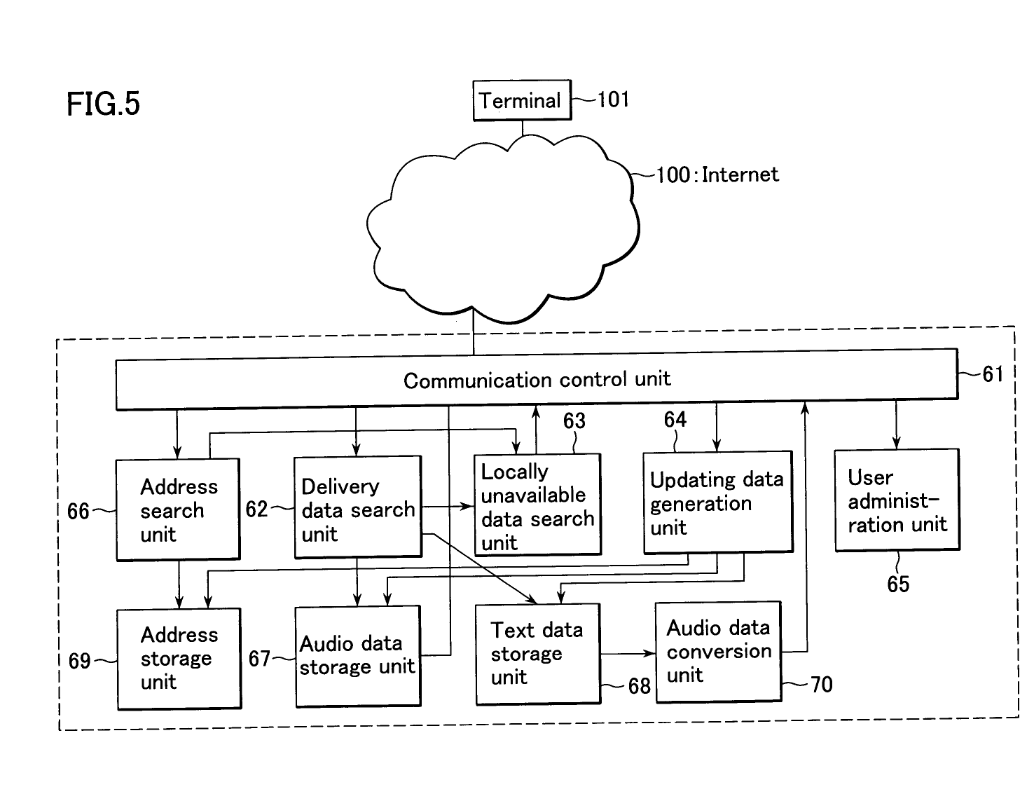

FIG. 5 is a configuration drawing indicating an example of a server of the present invention. In FIG. 5, the part enclosed with dashed lines shows the configuration of a server.

Communication control unit 61 executes communication control that allocates the audio data requested from more than one terminal 101 connected via Internet 100 to the relevant terminals. This unit also controls the transfer of received identifying information to delivery data search unit 62, the exchange of signals between locally unavailable data search unit 63 and other servers, the transfer of new audio data and text data received via the Internet to updating data generation unit 64, the transfer of user utilizing information acquired by terminals from ID cards and the like to user administration unit 65, etc.

Delivery data search unit 62 searches audio data or text data to be described later, related to the identifying information read at terminals to acquire the relevant data. More specifically, various data corresponding to the identifying information (arguments) can be searched by sending the identifying information to a server as an argument from each terminal and storing audio data or text data made correspondent to these arguments in advance in the server.

Address search unit 66 searches address data related to the identifying information read at the terminals and, if the relevant address exists in the server itself in which unit 66 is included, delivers the data to be delivered by taking the data out of its own server; if the related address exists in another server, address search unit 66 causes that server to directly deliver the audio data by linking to that address, or it delivers the audio data to the addressed terminal after having acquired the data into the server itself.

This enables the storage capacity of a server to be reduced because it is not necessary for one server to possess all the audio data to be delivered from the terminals.

In audio data storage unit 67, groups of audio data that are in the collection of the above described audio data are stored and kept in, for example, the MP3 (MPEG-1 Audio Layer-3) format.

The text data related to the identifying information are stored in text data storage unit 68. These text data include instructions, advertising copy, or the like corresponding to the identifying information. The relationship of the identifying information to the text data is the same as that for audio data.

Address storage unit 69 stores address data that are the storing places for audio data and text data within the server itself or other servers. The relationship of the address data to the identifying information is the same as that of the audio data or the like.

In addition, these address data include the concept of URLs and the like and they suffice to identify where audio data and text data are stored.

If the result of a search by delivery data search unit 62 or by address search unit 66 shows no relevant data, locally unavailable data search unit 63 searches whether or not the relevant audio data or text data exist in another server not shown in the drawing via the network and, if the data are found as the result of this search, locally unavailable data search unit 63 transfers the delivery request from the terminal to that server.

Audio data conversion unit 70 generates data speech-synthesized from the searched text data and converts the synthesized data into data format for transfer via a network using a compression technique such as, for e.g. MP3.

In addition, attribute information is attached to the text data and the text data are speech-synthesized using speech identified based on this attribute information. Specifically, the attribute information contains information for specifying a voice to be used in the speech-synthesis of text data from various voices of men and women of all ages and the information for intonating the synthesized speech. Thus this attribute information facilitates speech-synthesis selecting a specified voice or intonating the speech. This enables interpretation of products and others to be implemented multilaterally.

Further, it can also be adapted to judge the contents of the text data and to automatically select the type of speech to be synthesized based on that judgment.

Updating data generation unit 64 adds or updates the acquired new audio data and text data. The unit also deletes data which have become unnecessary for reasons such as, for example, having become out of date.

Updating data generation unit 64 can also change a linking destination by updating an address under which audio data and text data are stored.

This facilitates maintenance of servers.

In addition, delivery data stored in servers are not restricted to audio data and text data but may be various information including, for example, image data and character data. In this case, a display that can provides graphic display should be provided at the terminals. This enables various services of many kinds to be provided.

### Embodiment 2

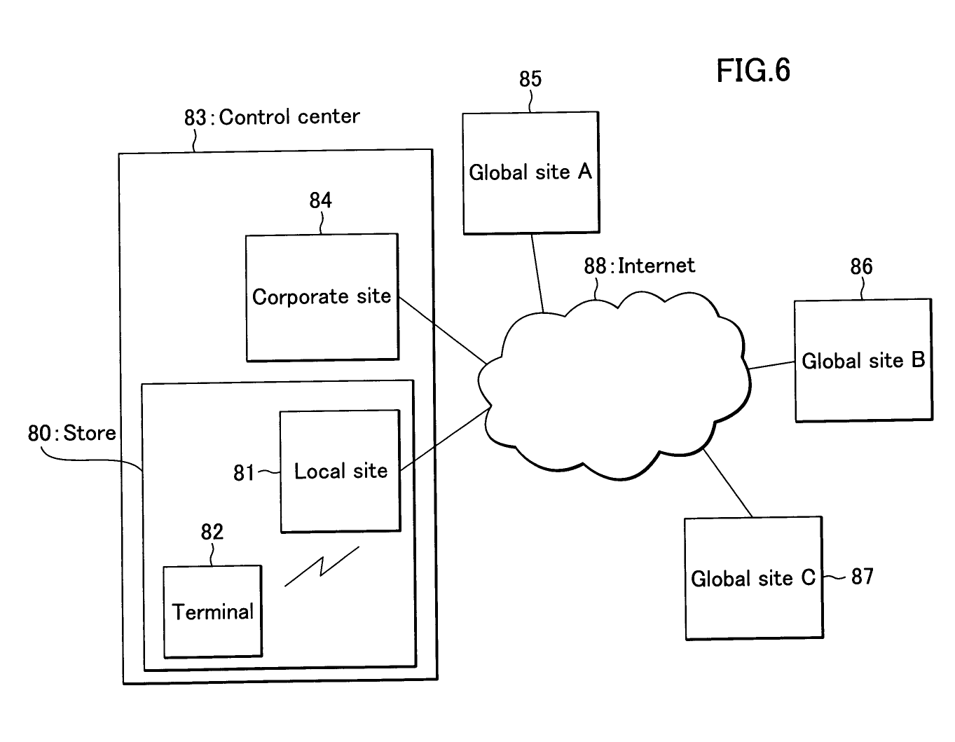

FIG. 6 is a configuration drawing indicating embodiment 2 of the present invention.

Local site 81 indicates a location where LAN is installed in store 80 and shows the site to which a server having the functions already described in FIG. 5 is connected.

Terminal 82 is a terminal which has the functions already described in FIG. 4 and is used in store 80.

Corporate site 84 is a site to control each group of stores and is connected to each store through the Internet or dedicated lines and is also a site in which the same server as that of local site 81 is provided.

Site A85, site B86, and site C87 which are global sites, are located in places remote from store 80 where LAN is constructed and from control center 83 which supervises store 80, LAN and others. At each of the sites is installed a server similar to that at local site 81 and corporate site 84. These sites are connected to the Internet.

Terminal 82 is connected to the network of the local site via wireless communication. This terminal may be connected to LAN at local site 81 or may be directly connected to Internet 88. Application of IPv6 facilitates connection to the Internet without requiring the NAT function.

Terminal 82 reads the identifying information from CDs or the like in store 80 and is connected to LAN at local site 81 or directly to Internet 88.

After reading the identifying information, terminal 82 sends the identifying information to a specific server according to network addresses for a plurality of destination servers stored in terminal 82. Accessing priority is set to network addresses for destination servers and access is executed in that order.

If different delivery data are stored for one kind of identifying information in servers at each site, after listening to a sample of music delivered from the server at local site 81, for example, one can listen to interpretation or the like delivered from the server at global site B 86. This interpretation or the like is stored in advance in the form of text data and is delivered after being converted to speech data by speech-synthesis and subjected to processing such as compression.

In addition, by storing addresses corresponding to identifying information in each server, the request can be linked to the address data.

Concretely, a server requested to deliver a kind of music data searches whether the corresponding data exist or not in its own server using the delivery data search function. If the music data that is searched for is found, it is transmitted by the server. If it is not found, however, address data corresponding to that music data are searched. If the corresponding address data are searched, and the relevant data is found, the server is connected to that address and causes the music data to be delivered from the connected destination. For example, newly released tunes or the like whose access frequencies are relatively high are stored in the server in a store, and others are stored in the servers at global sites and delivered from one of those servers only when such a tune is requested.

If the required music data, text data, or address data does not exist in its own server, other servers are searched for the relevant music data using the locally unavailable data search function.

Since a very large storing capacity is needed for music data or the like, a tremendously large storing capacity is required if all the music data to be delivered were to be stored in one server.

Accordingly, since the above function makes it possible to diversify the music data and others, each server is not required to have a very large storing capacity. This is effective for reducing costs.

Since a server has a function for updating stored music data or the like, it can implement additions or updating of data by receiving new music data remotely sent from other servers.

For instance, music data including newly released tunes can be collectively added to each store 80 from control center 83.

In addition to bar codes Radio Frequency-IDentification (RFID) tags or infrared tags can be attached to CDs or the like to make the identifying information correspondent to music data and others. This makes it possible to read the identifying information in a non-contact manner.

If terminal 82 is to be accessed by a user in store 80, the user's specific information is first read from the user's ID card. The user who accesses terminal 82 listens to the CD he/she is interested in by means of terminal 82. The history of this transaction is kept together with the user's specific information using the user information administration function. This facilitates the acquisition of information to be used for marketing research and so on.

Furthermore, using a personal computer as a transmission server, accumulated music data and speech data can be played back in a family home by means of wireless reception.

In addition, the bar code attached to an article is not restricted to being one-dimensional but can also be two-dimensional. If a bar code is two-dimensional, it can record much more information and thus, for example, audio data, speech data, etc. can be recorded in advance and played back as audible data at the relevant terminal.

As described in embodiment 1 and embodiment 2 above, the present invention has the following effects:

(1) More than one terminal or server can acquire global addresses by application of IPv6, and an audio delivery system can be achieved in which a terminal can receive audio data related to products and catalogs directly and a user can listen to the audio data before purchase via the Internet without requiring the NAT function by having a uniquely determined network address as described above.

In addition, various audio delivery systems can be realized, in which speech data and music data for interpretation systems, reading systems, foreign language learning systems, etc. are delivered to terminals via a network.

(2) A terminal can directly access servers via a network by storing a network address allocated to the terminal itself and network addresses allocated to the servers.

A terminal can also read the identifying information attached to the designated article and send it to a server via a network, and receive the delivery data from the server and supply the data to users after converting them to audible data.

(3) If a terminal stores different delivery data such as audio data and text data for the same identifying information in more than one server, different delivery data can be acquired by setting priority for accessing network addresses in more than one server according to their sequence. This enables wider delivery services to be offered.

If the same delivery data are stored in more than one server for the same identifying information, when a fault occurs in one server, another server can deliver those data in lieu of the faulty server, thereby achieving multiplexed delivery services.

(4) A terminal can be portable, and thus a user can listen to audio data in any desired place, for example, while moving about freely in a store.

(5) Since the program to control terminals can be updated externally, the addition of functions and/or a change of programs can be easily carried out.

(6) The identifying information can be simply obtained by using bar codes attached in advance to products or the like. Also, if a bar code is to be newly attached, this can be easily realized at low cost.

(7) Since the identifying information can be read in a non-contact manner, this can prevent the products and the like from being scratched.

(8) Relevant audio data can be delivered to terminals in response to delivery requests.

In addition, the data-storing capacity can be drastically reduced compared with the case where speech data are stored, by storing in advance explanations or the like concerning the products and others in the form of text data and creating speech data through synthesis of speech only when the speech data become necessary.

(9) The attribute information attached to text data facilitates speech-synthesis selecting a specified voice, for example, out of various voices of men and women of all ages or to intonate the speech. This enables explanations for products and the like to be implemented multilaterally.

(10) The location of audio data whose delivery is requested can be identified by a terminal having address data for audio data and text data stored its own server or other servers and the terminal can cause the audio data to be delivered by linking a specific address data item to that server. This does not necessitate all the audio data to be delivered from a terminal to be stored by one server and thus the storing capacity of a server can be reduced.

(11) If no audio data or text data to be delivered and no address data showing a linking destination in a server of an accessing destination can be found, data to be delivered can be searched for by accessing other servers which have been set in advance.

(12) Audio data and text data can be updated or newly added. Also, delivery data which have become unnecessary due to becoming outdated or the like can be eliminated. In addition, a linking destination can be changed by rewriting addresses in which audio data and text data are stored. This facilitates server maintenance.

(13) User-specific information read from a user's ID card and the identifying information for audio data that the user caused a terminal to deliver or the like can be administrated together, thus they can be actively used for data for marketing research and others.

What is claimed is:

1. An audio delivery system having a network address uniquely determined according to Internet Protocol Version 6 (IPv6) and comprising:
at least one terminal which reads identifying information from an identifying information recording part linked to a prescribed article and sends the information to at least one server set in advance via a network, as well as converts said received audio data to audible sounds or voices, and
at least one server which sends audio data related to said article to said terminal via a network based on said received identifying information.

2. An audio delivery system in accordance with claim 1, wherein said terminal comprises:
a reader unit which reads said identifying information,
a first address storage in which said network address is described,
a second address storage in which the network address of at least one sending destination server that sends said identifying information and said audio data delivery request is described,
a communication unit which sends said identifying information and said delivery request and receives said audio data,
an audio output unit which converts said received audio data to audible sounds or voices, and
a central processing unit which executes control programs and manages control of the whole terminal.

3. An audio delivery system in accordance with claim 2, wherein the accessing priority is set to network addresses in said sending destination server.

4. An audio delivery system in accordance with claim 2 or claim 3, wherein said communication unit is a wireless communication unit.

5. An audio delivery system in accordance with any of claim 2 to claim 4, wherein a program update function is provided, which updates existing said control program to a new control program acquired via said communication unit.

6. An audio delivery system in accordance with any of claim 1 to claim 5, wherein said identifying information is the information recorded by a bar code, is read by said reader unit and is input to said terminal.

7. An audio delivery system in accordance with any of claim 1 to claim 5, wherein said identifying information is the information output in the form of radio waves, is received by said reader unit and is input to said terminal.

8. An audio delivery system in accordance with any of claim 1 to claim 5, wherein said identifying information is the information output in the form of infrared rays, is received by said reader unit and input to said terminal.

9. An audio delivery system in accordance with any of claim 1 to claim 8, wherein said server comprises:
an audio data storage unit in which audio data groups related to said articles are stored, and
a delivery data search unit which searches the audio data corresponding to said identifying information out of said audio data groups.

10. An audio delivery system in accordance with any of claim 1 to claim 8, wherein said server comprises:
a text data storage unit in which text data groups for the information related to said articles are stored,
a delivery data search unit which searches for the text data corresponding to said identifying information out of said text data groups, and
an audio data conversion unit which speech-synthesizes said text data and converts them to audio data.

11. An audio delivery system in accordance with any of claim 1 to claim 8, wherein said server comprises:
an audio data storage unit in which audio data groups related to said articles are stored,
a text data storage unit in which text data groups for the information related to said articles are stored,
a delivery data search unit which searches related audio data or text data from said audio data groups or text data groups based on said identifying information, and
an audio data conversion unit which speech-synthesizes the searched text data and converts them to audio data.

12. An audio delivery system in accordance with claim 11, wherein attribute information is attached to said text data and speech-synthesis is implemented using specified voices based on said attribute information.

13. An audio delivery system in accordance with any of claim 1 to claim 12, wherein said server comprises:
an address storage unit in which addresses of said audio data or said text data stored in at least either the relevant server or other servers are described, and
an address search unit which searches for the relevant address from said related address storage unit based on said identifying information,
and further delivers the relevant audio data based on the searched address.

14. An audio delivery system in accordance with any of claim 9 to claim 13, wherein a locally unavailable data search unit is provided, which searches another server having the relevant data from preset servers, if the searched for result in at least either said delivery data search unit or said address search unit shows that there are no relevant data, and causes said delivery request from said terminal to be transferred to that searched server.

15. An audio delivery system in accordance with any of claim 9 to claim 14, wherein said server comprises an updating data generation unit which updates at least one of said audio data, said text data, or said addresses.

16. An audio delivery system in accordance with any of claim 1 to claim 15, wherein said server comprises a user administration unit which controls user utilization information read from an ID card by said terminal.
